(19) United States
(12) Patent Application Publication
(10) Pub. No.: US 2015/0305317 A1
(43) Pub. Date: Oct. 29, 2015

(54) Horseshoe Wedged Pad

(71) Applicant: Alfred Geoffrey Hall, Faringdon (GB)

(72) Inventor: Alfred Geoffrey Hall, Faringdon (GB)

(21) Appl. No.: 14/259,462

(22) Filed: Apr. 23, 2014

(51) Int. Cl. A01L 15/00; A01L 7/02

(52) U.S. Cl. CPC A01L 15/00; A01L 7/02

(57) ABSTRACT

A wedge pad for fitting between a shortened horseshoe and a horse's foot that has collapsed heels and/or a counter-rotated pedal bone. It provides support across the full width of the heel, raising it relative to the toe, correcting the angle and, being free from the fixation of a full shoe, allows natural expansion of the heel. There is a triangular central frog support sharing the load, reducing the total pressure on the damaged heel, and stimulating blood flow aiding recovery. The heel portion has a plurality of grooves on the ground contact surface, extending from toe to heel, providing greater flexibility. This adds to the cushioning effect provided by the thick heel portion, reducing the impact on the damaged heel. Preferably the pad is made from a resilient thermoplastic material that cushions the heel during impact (movement), thus reducing the stresses on the damaged tissues.

The invention relates to pads for fitting between a horseshoe and a horse's foot.

Horse's feet can suffer from a number of ailments or conditions. Many of these cause the horse significant pain or discomfort. They also alter the way the horse's weight is applied to the foot which can aggravate the conditions. Rapid correction is therefore desirable.

One particular condition which can often be difficult to treat is collapsed heels. In this condition the hoof wall at the rear (heel) of the foot collapses inwards towards the frog and thus the heel provides less support for the horse's weight. The weight is concentrated on a smaller area of the foot, which causes further wear and pressure on the rear of the hoof capsule, making it difficult for the heel to recover.

The problem can be particularly bad for horses wearing shoes. The shoe is nailed onto the hoof around the outer perimeter of the foot and thus applies the horse's weight to the outer perimeter of the foot, including the collapsed part of the heel, causing further pressure.

Common treatments for this syndrome use conventional resilient pads placed between the horseshoe and the horse's foot. The conventional pad is formed from a softer material than the shoe, e.g. a plastic or rubber composition which provides cushioning by absorbing the impact forces from walking. However, these pads are still less than fully effective for a number of reasons.

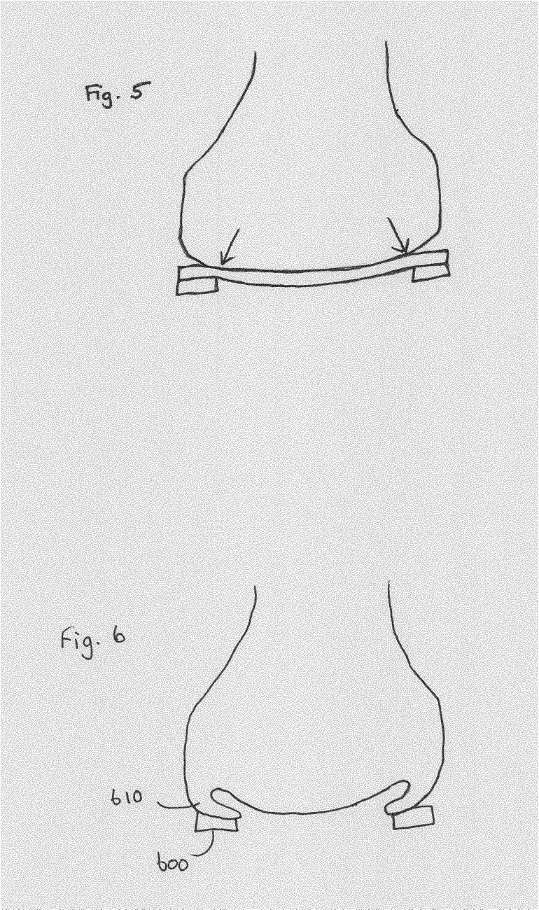

One problem with existing pads is that a full shoe is still nailed onto the foot through the pad. The harder material of the shoe (usually steel or aluminium) concentrates the impact forces through the outer part of the pad and onto the outer part of the foot. Meanwhile, the centre of the heel compresses the resilient pad. The hoof then digs into the softer material of the pad, preventing it from undergoing its natural expansion and contraction when weight is applied and released. This natural expansion and contraction is essential for quick recovery of a collapsed heel. If the heel does not expand and contract with each step, the inwardly curved hoof wall at the heel portion (i.e. the collapsed part of the heel) does not have a chance to regrow outwardly and to regain its original, healthy shape. This problem with the existing pads is illustrated in FIGS. 5 and 6. The arrows in FIG. 5 show where a crushed heel sinks into the pad and will not then slide along the pad, thus hindering further recovery. Further, as the shoe is nailed to the heel, the heel's movement is restricted, further preventing expansion and recovery of the heel.

FIG. 6 shows how the horn tubes of the hoof capsule fold inwards in a crushed heel and how a shoe nailed to the hoof clamps the hoof in place, preventing natural movement.

A further problem that occurs with collapsed heels is that the heel part of the hoof gets worn down more than the toe part of the hoof. This causes the angle of the foot to change, specifically causing the pedal bone of the foot to rotate relative to the ground. The term “rotated” is generally used to refer to a pedal bone that has been rotated so as to lower the toe relative to the heel. The term “counter-rotated” refers to a pedal bone that has rotated so as to raise the toe relative to the heel. This latter rotation is the one that typically occurs with collapsed heels. As the pedal bone counter-rotates, it squashes the sensitive tissues between the bone and the sole and causes pain and discomfort. It is therefore desirable to rotate the pedal bone back to its normal, healthy position as part of the treatment process.

Counter-rotation of the pedal bone is often treated using conventional wedge pads that raise the heel with respect to the toe. These pads are fitted between the rear of a normal shoe and the foot and they are wedge shaped, being thicker at the heel than they are towards the toe. However, these pads suffer from the same problem as conventional cushioning pads that are designed for a full shoe. That is, the pressure of the shoe and pad on the outside (collapsed part) of the heel compared with the lack of support in the central part of the heel prevents the natural expansion and contraction of the heel and hinders recovery of the collapsed heel. Further, these pads are always used with a full shoe to fix them to the rear area of the hoof. However, as described above, the nails passing through the shoe and wedge into the hoof clamp the collapsed heels firmly in place, loading the weight onto the collapsed part (which is turned inwards) and making the condition worse. As the wedge raises the heel with respect to the toe, greater pressure is applied to the turned in heel which then gets turned in further.

According to the invention, there is provided a pad that is wedge shaped for fitting between a horse shoe and a horse's foot, the pad comprising: an upper surface being a foot-contact surface, and a lower surface, the lower surface comprising: a front portion having a shoe-contact surface; and a heel portion having a ground-contact surface; wherein the shoe-contact surface and the ground-contact surface are parallel, but separated in height by a distance equal to the height of a horseshoe; and wherein the upper surface is at an angle to the lower surface so that the pad becomes thicker towards the rear.

The difference in height between the front portion and the rear portion is so that when a horseshoe is fitted onto the underside of the front portion (i.e. between the pad and the ground in use), the lower surface of the shoe is at the same level as the lower surface of the heel portion such that these two lower surfaces contact the ground simultaneously and distribute the horse's weight evenly around the weight-bearing circumference of the foot. At the same time, the shoe contact surface of the front portion of the pad is substantially flat in the region of the sole of the foot, i.e. in the region between the hoof wall and the frog. This means that it does not have additional structure that could transfer pressure through the pad and onto the sensitive tissues in the sole region of the foot. Apart from a central frog support portion discussed further below, the flat front portion of the pad extends radially outwardly to the side edges and the front edge of the pad. Substantially flat means that there are no significant projections from the surface that would be likely to cause additional ground contact on relatively flat ground. The term substantially flat here permits minor raised relief for lettering or a logo, e.g. to indicate a product name or identifier and/or a manufacturer or brand or the like. Additionally, some minor moulding marks such as are found at injection points on an injection moulded piece will not be detrimental to the flat nature of the surface. Such surface projections preferably project less than 2 mm, more preferably no more than 1 mm from the surface. The location of such marks should preferably be restricted to the area between the shoe and the frog (i.e. more central areas).

There is an additional wedge of material provided on top of the upper surface (foot contact surface). This wedge is thicker at the heel end than at the toe end

The upper surface of the pad is a continuous surface across both the front and rear portions. In other words, the upper surface of the front portion is the same surface as the upper surface of the heel portion, i.e. the two surfaces form a single plane. This upper surface is also preferably substantially flat across its entire surface. Again, no protrusions or other structures should be formed that could press on the sole of the foot when the pad is fitted. Again, minor surface relief may be provided, e.g. moulding points, but preferably these are restricted to the area between the frog and the hoof wall (i.e. the sole facing area) and are preferably less than 2 mm in height, more preferably 1 mm or less in height.

The wedge shaped pad provides support across the full width of the heel, thus allowing the natural expansion and contraction and at the same time raising the heel relative to the toe and allowing correction of the angle of the pedal bone. The wedge shaped pad is formed as a single unit, e.g. moulded as a single unit.

As mentioned above, a frog support portion is preferably provided with a thickness equal to the thickness of the heel portion and which extends forward from the heel portion towards a toe end of the pad. This frog support portion provides additional support for the horse's weight underneath the front part of the frog of the horse's foot (the rear part of the frog is supported by the heel portion). The frog is a weight-bearing surface in normal use and is designed to share the load of the horse's weight with the other parts of the heel and the hoof wall. Sharing the load across as much of the foot as possible in this way reduces the total pressure on the damaged heel portion, thus allowing the best possible chance of recovery. Additionally, weighting the frog functions to stimulate blood flow in the foot which aids recovery.

The frog support portion is preferably in the form of a triangle extending forwardly (towards the toe) from the front edge (the edge nearest the toe) of the rear (heel) portion. This triangle has a base parallel and coincident with the front edge of the heel portion and an apex closer to the front (toe) edge of the pad. The triangle is generally (or approximately) triangular, meaning that the apex need not be a point, but may be rounded or truncated and the base of the triangle may be joined smoothly to the front edge of the heel part, e.g. by a radius, or otherwise buttressed so as to reduce stresses in the pad that could be caused by sharp corners and to facilitate moulding. Further, forward projections extending forward from the heel portion may also be provided either side of the frog support portion to provide further strength to the pad. Preferably these extend forward no more than 10 mm.

The frog support portion preferably extends forward to approximately two thirds the length of the pad (as the frog of a healthy foot normally extends two thirds the length of the foot), and in any case, preferably not more than 80% of the length of the pad, more preferably not more than 70%, but most preferably not more than about two thirds of the length of the pad. The width of the widest part of the frog support portion (where the base joins the rear/heel portion of the pad) is preferably not more than 30% of the width of the widest part of the pad, more preferably not more than 25% of the width of the pad. The width of the pad in this context is the dimension that extends between the left and right sides of the pad as viewed by the horse when the pad is in use (i.e. the terms “left” and “right” referring to the horse's perspective). It will be appreciated that these relative measurements relate to preferred embodiments of the pad.

In preferred embodiments, the heel portion has a plurality of grooves on the ground contact surface thereof, each groove extending in the direction from toe to heel. These grooves provide greater flexibility to the pad in its thickest portion, allowing the pad to bend and flex laterally. This adds to the cushioning effect provided by the thick heel portion, reducing the impacts on the damaged heel.

Preferably the pad is made from a resilient material that cushions the heel during impacts (as the foot is placed and lifted), thus reducing the stresses on the damaged heel tissues. The material preferably also has a coefficient of friction with a horse's heel that allows the heel to slide with respect to the pad during the natural expansion and contraction of the heel. Preferably the pad is made from a plastics or rubber (or other elastomeric) material.

The pad may be opaque, but in some preferred embodiments it may have a degree of transparency. This facilitates proper placement of the pad with respect to the foot, e.g. location of the frog support portion directly underneath the frog. This is particularly important in cases where the pad is larger than the foot that is to be treated. In such cases the pad will be trimmed down to the size and shape of the foot and it is desirable to keep the frog support portion optimally located during the trimming process. This is facilitated if the fitter can hold the pad against the foot, see through the pad to co-locate the frog and the frog support portion, then mark the pad for trimming.

It will be appreciated that pads can be designed for different sizes of shoe, with different thicknesses. The difference in thickness between the front and rear portions of the pad is determined by the thickness of the shoe that it is intended to be fitted with. A skilled person can readily select appropriate thicknesses. However, in some preferred embodiments the heel portion is thicker than the toe portion by 5 to 10 mm.

This thickness change represents the thickness gain across the boundary between the front portion and the rear heel portion. In general this may be a step change in thickness, but equally a steep gradient may be used to facilitate removal of the pad from a mould. Similarly, the frog support portion stands proud of the front portion with a step or steep gradient between the two. A steep gradient means preferably not less than 45 degrees, more preferably not less than 60 degrees to the horizontal.

In preferred embodiments the heel edge extends across almost the full width of the pad. For example, the width of the heel at the rear edge may be greater than 60%, or in some embodiments greater than 70% of the widest part of the pad. The rear edge is preferably straight, i.e. it extends in a substantially straight line. It will be understood that the corners of the pad (i.e. the rear right and rear left corners in use) may be rounded so as to avoid sharp edges and to facilitate moulding, but the radius of these corners is preferably small in comparison to the width of the pad so that the rear edge extends essentially straight across a large portion of the width of the pad. In use, the large width preferably accommodates the entire width of the heel of the foot to be treated, thus providing support across the entire width of the heel. Horses' feet come in a large variety of sizes and shapes, but the small radius used in the corners leads to substantially square corners with a rear edge which will be wider than most heels when the other dimensions of the pad are fitted appropriately to the foot. The heel part of the pad can then be rasped down to the size and shape of the foot. Starting from a size greater than the foot ensures that the pad is always large enough in the heel part to support the heel across substantially its entire width, thus distributing load evenly across the heel even when the heel undergoes its natural expansion under load.

Once a more normal angle of pedal bone has been achieved, and the heels have recovered and the heel portion of the hoof has grown back to a normal shape, the wedge shaped pad is no longer necessary.

The timescale for such applications will be decided by a skilled person according to each individual case, but the pads are preferably replaced at the same time as the shoes and thus the pad replacement will be selected to coincide with the normal re-shoeing cycle. This is typically around every 6 weeks (e.g. 4 to 8 weeks), but may be longer or shorter depending on the circumstances. The length of time that a wedge pad is used may vary greatly. It could be as little as 4 weeks (one short shoeing cycle) and there is no upper limit to the length of time spent using wedge pads. The hoof care professional will decide when it is appropriate based on the shape and health of the hoof and foot.

As mentioned above, one of the main problems with existing heel wedges is that they are always used together with a full-size shoe that is nailed to the heel of the hoof as well as the toe of the hoof. This clamps the pad to the heel and prevents movement of the heel. When the heel is clamped in this way, it typically digs into the soft material of the pad, thus further hindering movement. Existing wedge pads require fixing at the rear (heel) end of the foot to secure them adequately to the foot. However, the pads according to the invention can be adequately secured (e.g. nailed, adhered or otherwise fixed) to the foot at the front part, leaving the heel free to move relative to the rear part of the pad. The use of a shortened shoe at the front of the pad provides good support and protection to the toe end of the foot while the heel is being treated as well as securing the pad firmly to the foot. In preferred embodiments the pad is designed to accommodate a shoe shortened to about two thirds the size that would normally be used. In some preferred embodiments the shoe is shortened to be less than 80% of a normal shoe length, and in some cases less than 70% of a normal shoe length. In some preferred embodiments the shoe is shortened by between a quarter and a third of its length.

In preferred embodiments the angle between the lower surface and the upper surface of the pad is between 2 degrees and 5 degrees, more preferably between 2.5 degrees and 3.5 degrees.

The different aspects of the invention are strongly inter-related and the preferred features described above in relation to the different aspects of the invention are applicable to all aspects of the invention.

It will be understood that pads may be used for one foot only. However, the condition often arises in two or more feet simultaneously and so pads will often be used on all affected feet. The time spent on wedge pads may also differ between the two feet, each foot being assessed on its own merits before stopping pad application all together.

Although the description above and below is all given in the context of horse feet, it will be appreciated that the pads are equally applicable to other equids, e.g donkeys, mules and zebras.

Preferred embodiments of the invention will now be described, by way of example only, and with reference to the accompanying drawings in which:

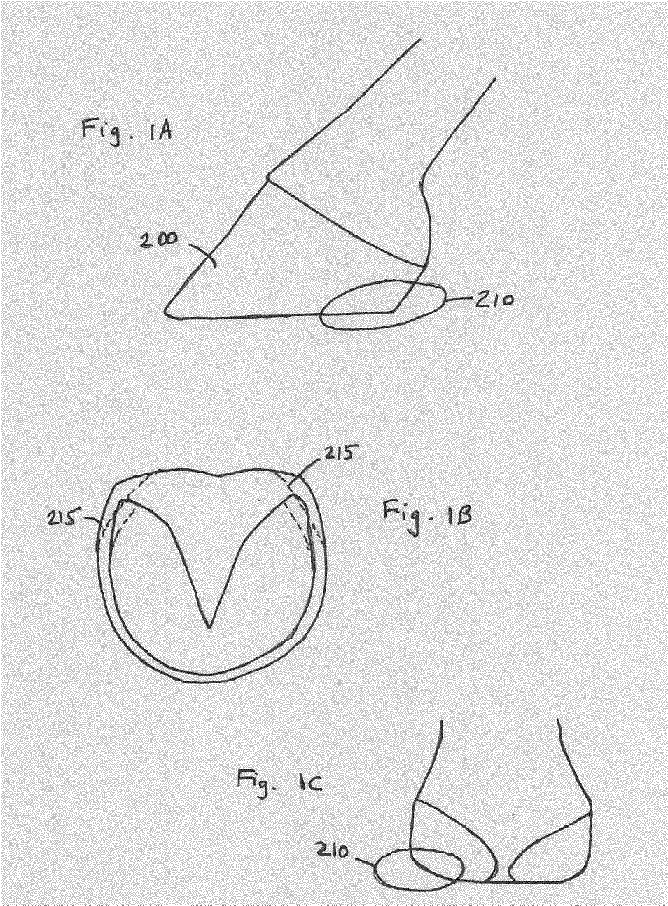

FIG. 1A shows a lateral view of a horse's foot;

FIG. 1B shows a view of a horse's foot from beneath;

FIG. 1C shows a rear view of a horse's foot with a collapsed heel;

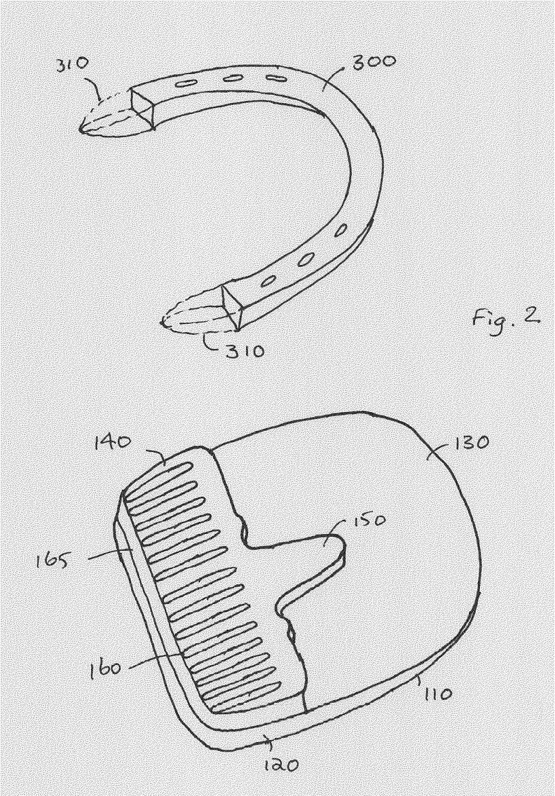

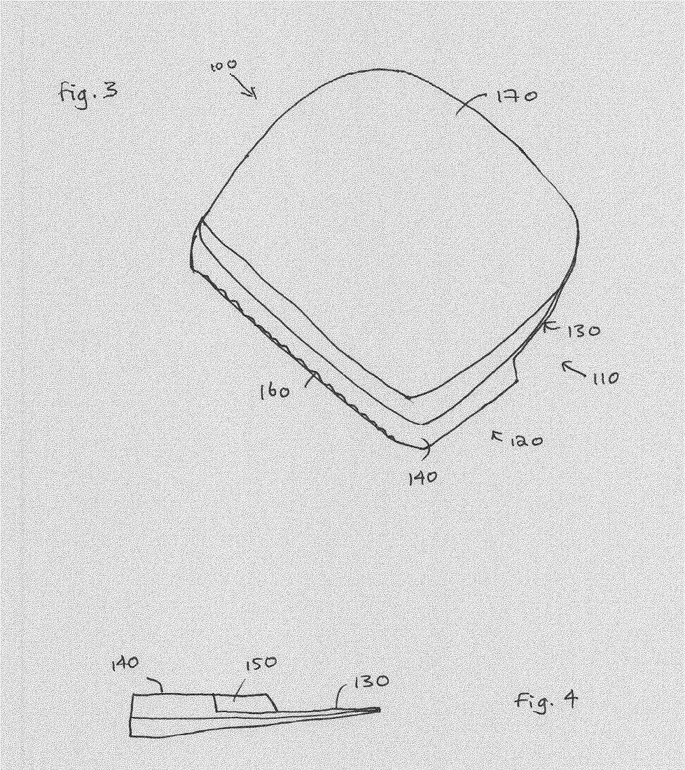

FIG. 2 shows a perspective view of an underside of a pad together with a shoe;

FIG. 3 shows a perspective view of an upper side of a pad;

FIG. 4 shows a side view of the wedged pad;

FIG. 5 shows a rear view of a conventional pad with a full horseshoe;

FIG. 6 shows a folded-in part of a collapsed heel;

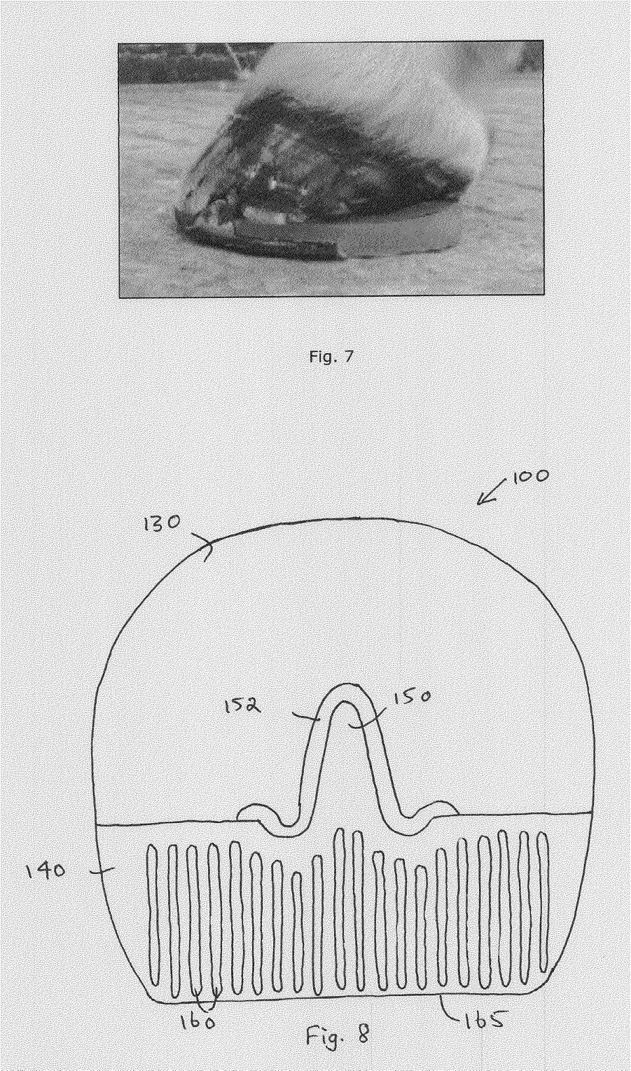

FIG. 7 is a photograph of a side view of a foot with a shoe and pad fitted; and

FIG. 8 shows a plan view of the underside of a pad.

FIGS. 1A and 1B show a horse's foot from the side and bottom respectively. The hoof capsule 200 is designated generally by reference numeral 200. The heel area which can collapse inwards is identified by the circle 210 in FIG. 1A and shown by dashed lines 215 in FIG. 1B. FIG. 1C illustrates the profile of a horse's foot viewed from the rear, showing a collapsed heel, again identified by circle 210 and showing how the hoof wall does not extend essentially perpendicular to the ground (as would be the case for a healthy hoof), but is curved inwards towards the central (frog) region of the heel. The smaller ground contact region can clearly be seen in this figure.

FIG. 6 also illustrates how the hoof wall 610 of a collapsed heel turns inwards. The hoof wall 610 gets bent inwardly at the bottom (in contact with the ground). Once turned in like this, the hoof wall will tend to continue growing inwardly as pressure is applied onto the side wall of the hoof, unless the hoof is reshaped and helped to grow back into a normal shape. FIG. 6 also shows how a full shoe 600 nailed onto the bent wall 610 clamps the damaged part of the heel in place, preventing it from expanding naturally under load and thus making the condition worse.

An embodiment of a pad 100 according to the invention is shown in FIGS. 2 and 3. FIG. 2 shows the pad 100 with its ground-contact surface showing uppermost in the figure. The pad can be divided into three sections: the rear or heel section 140 is located at the rear of the pad 100, designed for placement underneath the heel of a horse's foot. This section of the pad 100 is thicker than the front or toe portion 130. The third section is the frog section 150 which extends forwardly (towards the toe end) from the heel portion 140 in the middle of the pad. The frog section is designed to be located underneath the front part of the frog of a horse's foot (the rear part of the frog is supported by heel portion 140). The frog portion 150 of pad 100 is the same thickness as the heel portion 140, i.e. it is thicker than the front or toe portion 130.

The toe portion 130 of the pad 100 as referred to in this document is defined to be the whole of the pad 100 other than the heel portion 140 and the frog portion 150. The toe portion 130 is substantially flat on its lower surface (the surface facing the ground in use), i.e. it does not contain any other structure projecting from that surface towards the ground which could make contact with the ground and transfer pressure through the pad and onto the sole of the horse's foot during weight bearing. Minor raised lettering may be provided on the flat surface without ill-effect and such surfaces are still considered to be substantially flat. The lettering may indicate a manufacturer, product ID, size, or similar. The lettering is preferably only about 1 mm high (i.e. extends no more than 1 mm from the surface). Alternatively, inset lettering may be used instead, preferably with a similar depth of no more than 2 mm, preferably no more than 1 mm).

FIG. 2 also shows a horseshoe 300 which is to be used with the pad 100. The horseshoe 300 is not a full size horseshoe, but has been cut down by cutting off the rear portion of the side bars. The portion which has been cut away from a full size shoe is indicated by dotted lines 310. The remaining part of the horseshoe is therefore sized to fit onto the toe portion 130 of the pad 100. The difference in thickness between the toe portion 130 and the heel portion 140 of pad 100 is approximately equal to the height of horseshoe 300 so that when the horseshoe 300 is fitted onto the toe portion 130, the heel portion 140 has the same thickness as the combined thickness of the shoe 300 and toe portion 130. It will be appreciated that a purpose-designed shoe could be used instead of cutting a normal sized shoe down to size. Together, the combination of the pad 100 and shoe 300 will contact flat ground along substantially the entire lower surface of the shoe 300, substantially the entire lower surface of the heel portion 140 and substantially the entire lower surface of the frog portion 150. No other portion of the pad 100 should make contact with flat ground during use.

It will be appreciated that if used on rough or uneven ground, parts of the toe portion 130 could come into contact with raised portions of the uneven ground, but this is no different from the normal situation on such ground. While a horse is being treated for collapsed heels, it will normally spend more (or all) time on flatter, even ground to facilitate recovery.

In general, the thickness change between the toe portion 130 and the heel portion 140 may be a step change in thickness, but equally a steep gradient may be used to facilitate removal of the pad 100 from a mould. Similarly, the frog support portion 150 stands proud of the front portion 130 with a step or steep gradient between the two. A steep gradient means preferably not less than 45 degrees, more preferably not less than 60 degrees to the horizontal. A steep gradient around frog portion 150 is illustrated in FIG. 8 by reference numeral 152.

Because the shoe 300 is shorter than a standard shoe, it is only nailed onto the hoof 200 in the front part thereof, i.e. at the toe or front quarters. The heel is not nailed or otherwise fixed to either the shoe 300 or the pad 100. Therefore the heel is free to undergo its normal expansion and contraction process as the foot is weighted and unweighted.

To facilitate this expansion and contraction process, the material of the pad is chosen so as to have a low enough coefficient of friction that the hoof can slide with respect to the pad. One preferred material for the pad is thermoplastic polyurethane.

The heel portion 140 also has grooves 160 extending across the lower (ground-contact) surface thereof. These grooves provide added traction as well as adding flexibility to the heel portion 140 so that it can bend around the central (front-rear) axis.

FIG. 3 shows the upper surface 170 of the pad 100. The upper surface 170 is substantially flat across its entire extent. In use, the upper surface 170 is placed in contact with the lower surface of the foot. In practice, this means that the upper surface 170 will contact the frog and the hoof wall of the horse's foot, as well as the rear bars. Each of these contact points is directly supported, by the shoe 300 in the case of the toe part of the hoof wall, by the heel portion 140 and frog portion 150 in the case of the frog, and by the heel portion 140 of the pad in the case of the rear bars. The sole which can be tender and which can be thin in thoroughbred horses is generally not in contact with the upper surface 170 of pad 100, but even if it does contact the upper surface 170, there is no underlying structure to transfer pressure from the ground, through the pad 100 and onto the sole.

FIG. 4 shows a side view of a wedge shaped pad. The angle of the pad may be varied according to the severity of the horse's condition.

Pads may be provided in a number of shapes and sizes for different shaped and sized feet. However, for simplicity, it is preferred to provide a relatively small number of sizes which can then be trimmed to the exact shape and size of the horse's foot. For this reason, the heel portion 140 of the pad is typically formed slightly wider than the average heel in order to accommodate a greater range of foot sizes. A farrier will rasp the pad down to size as part of the fitting process.

As shown in FIGS. 2 and 8, the rear edge 165 of pad 100 is a straight edge. By contrast, the front edge is rounded to match the shape of a typical toe (although the pad may be larger as described above). Thus the pad as a whole is approximately D-shaped when viewed from above. The pad tapers slightly towards the rear edge 165 and the rear corners are slightly rounded for ease of manufacture and for a softer appearance, but the rear edge 165 is predominantly straight, i.e. it extends straight for around 60% or more of the maximum width of the pad (70% or more in some embodiments). In many cases, this wide heel will be wider than is required to fit the foot, but it ensures a good fit to a larger range of foot sizes and shapes and can be rasped down to an appropriate size and shape for the given application (i.e. for the particular foot to be treated). The wide heel part 140 then provides good support across the full width of the heel even when the heel expands slightly under load. This support is important to the recovery of a collapsed heel and therefore the wide heel of the pad provides an improvement over rounded or oval shaped heel part.

In some examples, the length of a wedge pad (from toe to heel) may be between about 100 mm and 250 mm. The width of the pad (from left to right) may be between 100 mm and 250 mm. In some preferred embodiments the length and the width are approximately the same (to within 5%). The minimum height of the front portion (at the toe edge) may be between 3 mm and 6 mm and the maximum height of the heel portion (at the heel edge) may be between 15 mm and 30 mm.

The distance from the apex of the frog support portion may be between 65 mm and 170 mm and the widest part of the frog support portion may be between 20 mm and 50 mm.

It will be appreciated that these ranges are merely examples and that the invention covers pads with dimensions outside of these ranges. The ranges are given here merely for the purpose of illustration.

As further illustration (and not by way of limitation), an example of a set of four different sized pads was measured as follows (it will be appreciated that these are only approximate measurements of single instances of the pads and thus are subject to manufacturing and measurement tolerances):

TABLE 1

| | Wedged pads | | | |
|---|---|---|---|---|
| | Pad 1 | Pad 2 | Pad 3 | Pad 4 |
| Length (toe to heel) | 143 mm | 157 mm | 170 mm | 185 mm |
| Width (left to right) | 146 mm | 160 mm | 173 mm | 188 mm |
| Min height of front portion | 4 mm | 5 mm | 5 mm | 5 mm |
| Max height of heel portion | 20 mm | 22 mm | 23 mm | 23 mm |
| Distance of frog apex to rear | 92 mm | 102 mm | 111 mm | 121 mm |
| edge | | | | |
| Max width of frog portion | 30 mm | 35 mm | 36 mm | 40 mm |

The wedged pads are angled so as to raise the heel thickness by about 5 to 15 mm at the rear edge, leading to wedge angles of between about 1 and 10 degrees (although in some preferred embodiments, about 2 to about 4 degrees).

The fitting process is straightforward. The pad 100 is shaped and sized to the shape and size of the horse's foot to which the pad is to be fitted. A shoe 300 (typically steel or aluminium) is cut down to fit into the toe part 130 of the pad 100 (by removing the portion indicated by dotted lines 310 in FIG. 2), with its rear extent butting up against the thicker heel portion 140 of the pad 100. The pad 100 and shoe 300 are positioned onto the underside of the horse's foot and nails are driven through the shoe, the pad and the hoof in a conventional fashion so as to hold the shoe and pad to the hoof. As the shoe 300 is only fitted to the front part of the pad 100, no nails are driven into the heel of the foot through the heel portion 140 of the pad 100.

FIG. 7 shows a side view of a foot with a pad 100 as described above and a shortened shoe 300 attaching the pad 100 to the hoof.

1. A wedge shaped pad for fitting between a horse shoe and a horse's foot, the pad comprising:
an upper surface being a foot-contact surface, and
a lower surface, the lower surface comprising:
a front portion having a shoe-contact surface; and
a heel portion having a ground-contact surface;
wherein:
the thickness of the heel portion is greater than the thickness of the front portion by an amount equal to the height of a horseshoe; and the shoe-contact surface of the front portion being at an angle to the foot-contact surface of the front portion.
wherein:
the upper surface is at an angle to the lower surface so that the pad becomes thicker towards the rear.

2. A pad as claimed in claim 1, wherein the angle between the lower surface and the upper surface is between 2.5 degrees and 3.5 degrees.

3. A pad as claimed in claim 1 or 2, wherein a frog support portion is provided with a thickness equal to the thickness of the heel portion and which extends forward from the heel portion towards a toe end of the pad.

4. A pad as claimed in claim 3, wherein the frog support portion is approximately triangular in shape.

5. A pad as claimed in any preceding claim, wherein the heel portion has a plurality of grooves on the ground contact surface thereof, each groove extending in the direction from toe to heel.

6. A pad as claimed in any preceding claim, wherein the pad is made from plastics or rubber.

7. A pad as claimed in any preceding claim, wherein the heel portion is thicker than the toe portion by 5 to 10 mm.

8. A method of correcting a horse foot with a collapsed heel and counter-rotated pedal bone, comprising:
placing a wedged pad according to any preceding claim to the underside of the foot;
placing a cut-off shoe adjacent to the front portion of the pad; and
fixing the shoe to the foot through the pad.

9. A pad substantially as hereinbefore described, and with reference to FIGS. 2, 3 & 4 of the accompanying drawings.
